(19) United States
(12) Patent Application Publication
(10) Pub. No.: US 2002/0140870 A1
(43) Pub. Date: Oct. 3, 2002

(54) Entertainment receiver activated in response to received program content and method of operating same

(75) Inventors: Srinivas Gutta, Buchanan, NY (US); Tomas Brodsky, Croton on Hudson, NY (US); Lalitha Agnihotri, Fishkill, NY (US); Mi-Suen Lee, Ossining, NY (US); Santhana Krishnamachari, Ossining, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/821,028

(22) Filed: Mar. 30, 2001

(51) Int. Cl. H04N 5/445; H04N 5/46

(52) U.S. Cl. 348/729; 348/554

(57) ABSTRACT

An entertainment receiver is tuned in response to at least one signal indicative of preferred program content type for a user of the receiver. In response to received and detected program content type, program content type of plural program sources received by the receiver is determined. The program content type of the plural received program sources is compared with the stored signal indicative of preferred program content type for a user of the receiver. The receiver is activated so a received program source with the preferred program content type is presented to the user.

### FIELD OF INVENTION

The present invention relates generally to entertainment receivers and methods of operating same and, more particularly, to an entertainment receiver and method wherein the receiver is activated in response to received program content.

### BACKGROUND ART

A typical entertainment receiver such as a portable, automotive or home radio receiver or a television receiver, includes a tuner for passing a carrier frequency of a program source and program information modulated on the carrier frequency to circuitry for driving an output device including one or more speakers. In many receivers, a user presets the carrier frequencies a tuner passes by activating buttons on a console or a remote control unit. The user accesses program sources by pressing one or more of the buttons. In many radio receivers, a frequency band is scanned for available stations, that is, stations having received signal strengths in excess of a threshold. The program content of the available stations is typically presented in order of increasing or decreasing frequency. Such scanning is usually performed by activating two buttons on the receiver console.

We are aware that a more sophisticated system, referred to as the radio data system (RDS), has been developed for frequency modulation (FM) transmitters and receivers. In the RDS system, digital data indicative of program content type are transmitted on a subcarrier of a program source. An FM receiver with RDS capability responds to the subcarrier to activate a display to provide a user of the receiver with a visual indication of the program content type. A receiver responsive to the RDS transmitter includes push buttons enabling the user to insert into the receiver the type of programming he/she desires to hear. The receiver responds to the listener's input and compares the program type codes the receiver receives from the various RDS transmitters and matches one of the received programs with the desired program type. RDS has the disadvantages of requiring special RDS transmitters and incompatibility with amplitude modulated (AM) program sources.

It is, accordingly, an object to the present invention to provide a new and improved entertainment receiver apparatus and method wherein a tuner is activated to provide a user with program content type corresponding with preferences of the user.

Another object of the present invention is to provide a new and improved entertainment receiver apparatus and method wherein a tuner is activated to provide a user with program content type corresponding with preferences of the user, which apparatus and method can be used in connection with AM or FM radio receivers, or television receivers, and does not require specialized transmitters.

### SUMMARY OF THE INVENTION

In accordance with the present invention, an entertainment receiver is tuned in response to at least one stored signal indicative of preferred program content type for a user of the receiver. In response to received and detected program content type, a determination is made of program content type of a plurality of program sources received by the receiver. The program content type of the plurality of program sources received by the receiver is compared with the stored signal indicative of preferred program content type for the user of the receiver. The receiver is activated so a received program source with the preferred program content type is presented to the user. The activation can be manual in response to a display or automatic.

In accordance with a preferred embodiment of the invention, a first tuner of the receiver is activated through a gamut of frequencies. The program content types of program segments passed through the first tuner for frequencies in the gamut of frequencies are classified. The comparing step is performed in response to the classified program content types passed through the first tuner. The activating step is performed by setting a second tuner to pass a carrier frequency of a received program source with the preferred program content type. The second tuner derives an output signal that is ultimately supplied in aural form to the user.

In accordance with a further preferred embodiment of the invention, the carrier frequency passed by the second tuner is changed to a carrier frequency of another received program source with the preferred program content type in response to the amplitude of the signal level passed by the second tuner dropping below a threshold level associated with transmissions from distant and/or low-power broadcast stations. Hence, the program source tuned to by the receiver is changed to another received program source with the preferred program content type in response to the amplitude of the received program source dropping below the threshold level. This feature is of particular importance for portable and automotive radio receivers moving from one region to another. It is accomplished by performing the previously mentioned determining, comparing and activating steps.

The program content type signals can be derived by using an explicit mode, an implicit mode, or a combination of explicit and implicit modes. In the explicit mode, the preferred program content type is derived in response to input signals associated with inputs of the user derived from sources other than received program content, for example, manually keyed inputs by the user of preferred program content type. In the implicit mode, the preferred content type is derived in response to signals resulting from received program content. In the combined mode, the stored program content type signals can be initially derived in the explicit mode and modified in response to information derived from the implicit mode.

The further feature of the invention is that the receiver is adapted for use with different predetermined users. In such a case, a storage arrangement stores preferences for the different users. Identification of the different users can be performed automatically, for example, by using transducers responsive to the appearance or weight of the users. Alternatively, user identification can be established manually by activating a key or set of keys.

The above and still further objects, features and advantages of the present invention will become apparent upon consideration of the following detailed descriptions of specific embodiments thereof, especially when taken in conjunction with the accompanying drawings.

### BRIEF DESCRIPTION OF DRAWINGS

FIG. 1 is a block diagram of a preferred embodiment of a radio receiver in accordance with one embodiment of the present invention;

FIG. 2 is a flow diagram for the operation of the receiver of FIG. 1 in the explicit mode; and

FIG. 3 is a block diagram of another preferred embodiment of a radio receiver in accordance with the present invention, wherein the receiver is particularly adapted for use in automotive vehicles and includes a signal strength detector arrangement.

### DETAILED DESCRIPTION OF DRAWINGS

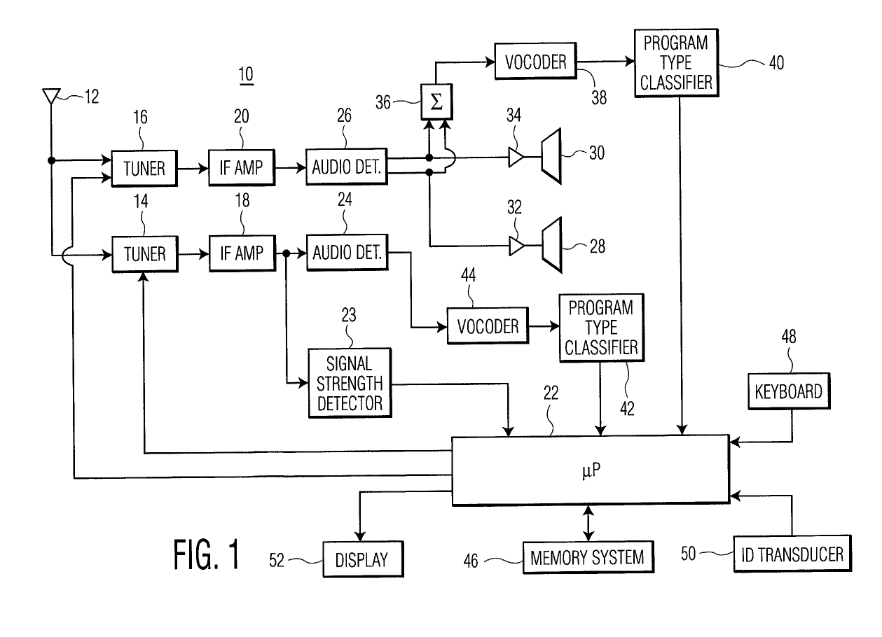

Reference is now made to FIG. 1 of the drawing wherein radio receiver 10, which can be of the AM or FM type and can function in response to a standard broadcast signal that does not have RDS coding, includes antenna 12 which drives tuners 14 and 16 in parallel. Tuners 14 and 16 respond to the same band of frequencies, such as the standard broadcast AM or FM bands, to derive intermediate frequencies (IF) that respectively drive IF amplifiers 18 and 20. Microprocessor 22 derives stair step voltages which control voltage controlled oscillators and filters in tuners 14 and 16 to control the center frequencies of the tuners and the carrier frequencies and broadcast content the tuners pass to IF amplifiers 18 and 20.

Amplifier 18 drives signal strength detector 23 which supplies microprocessor 22 with a DC voltage having an amplitude proportional to the envelope of the amplifier 18 output. Microprocessor 22 responds to the DC voltage that detector 23 derives to determine if the voltage is above or below a threshold. If the voltage exceeds the threshold, microprocessor 22 generates a signal indicating that the frequency of tuner 14 associated with the DC voltage is an available program source, i.e., an available station.

Amplifiers 18 and 20 respectively drive audio detectors 24 and 26, either of the AM or FM type, as appropriate. If receiver 10 is of the FM type, detector 24 derives a monaural output signal, while detector 26 derives stereo components that drive speakers 28 and 30 through audio amplifiers 32 and 34, respectively. The stereo outputs of detector 26 drive analog summing circuit 36, which in turn drives vocoder 38.

Vocoder 38 has a digital output for driving program type classifier 40 which can be of any suitable type, such as disclosed by Pfeiffer et al. in an article entitled Automatic Audio Content Analysis, published in the Proceedings ACM Multimedia 96, Boston, Mass., Nov. 18-22, 1996. In a preferred embodiment, program type classifier 40 is an application specific integrated circuit (ASIC), or the function of classifier 40 can be included in microprocessor 22 and memory system 46.

Program type classifier 40 derives a digital output signal indicative of the program content of the program signal passed through tuner 16. Classifier 40 derives one of several different digital signals indicative of the genre, or music type or talk type of the program signal passed through tuner 16. If the program signal is a music type, classifier 40 derives a signal indicative of the type of music, for example, classical, country, rock, swing or jazz. If the program is a talk type, classifier 40 derives a signal indicative of the type of talk, for example, news, telephone talk shows, sports or drama.

Classifier 40 can recognize program content by using feature or template based approaches. For example, music and music type can be recognized by responding to the fact that songs with lyrics usually start with only instrumental content and after a few seconds, the lyrics are blended with the instrumental content. Classifier 40 derives a template for the first few seconds. Alternatively, classifier 40 performs a speech to text conversion. If classifier 40 performs such a conversion, the conversion is performed on a program or subprogram level. A program usually contains several segments; e.g., a news program usually contains weather, financial, traffic, local, national and international segments. Classifier 40 responds to such segments at the subprogram level to derive output signals associated with the content of each segment.

The digital output signal of classifier 40 drives one input of microprocessor 22, having a second input responsive to an output of content type classifier 42, which is constructed identically to classifier 40; classified 40 and 42 are shown as separate elements to simplify the drawing, but it is to be understood that the functions they perform can be done by a single element that is suitably multiplexed. Classifier 42 responds to an output signal of vocoder 44, in turn responsive to the output signal of detector 24. Microprocessor 22 continuously steps the carrier frequency which tuner 14 supplies to IF amplifier 18 through a gamut of frequencies in the frequency band to which tuner 14 responds. Typically, each step has a duration of approximately 30 seconds, a sufficiently long interval to enable classifier 42 to derive a signal indicative of the program content type for each frequency in the gamut.

Microprocessor 22 responds to the output signals of classifiers 40 and 42 and to signals stored in memory system 46 and derived from keyboard 48 to drive tuner 16 so that tuner 16 passes to amplifier 20 a carrier frequency on which is modulated a signal associated with preferred program content of the user. Hence speakers 28 and 30 provide the user with aural program content the user prefers and classifier 40 supplies microprocessor 22 with a signal indicating the user's preferred program content.

User identification transducer 50, which, for example, can be a video camera or a weighing scale in a driver's seat of automotive vehicle, supplies microprocessor 22 with an indication of the receiver user. Microprocessor 22 responds to the signal from transducer 50 and a signal memory system 46 stores to supply the memory system with a signal indicative of the user identity. Alternatively, the user can activate a key or set of keys on keyboard 48 to provide microprocessor 22 with an indication of the user.

Memory system 46 can include, as necessary, a random access memory (RAM), read-only memory (ROM), a hard disk, and a slot arrangement for a floppy disk and/or a CD-ROM. Memory system 46 stores signals (1) for enabling microprocessor 22 to control the gamut of frequencies through which tuner 14 is stepped, that is, the stations available to receiver 10, (2) program content for stations available to receiver 10, (3) user identifications, [and] (4) preferred program content type for each of the identified users, (5) software/implementation, and (6) templates/features.

The preferred program content type that memory system 46 stores corresponds with approaches classifier 40 and 42 use. If classifiers 40 and 42 use a feature based approach, memory system 40 stores features of desired program type for each user. If classifiers 40 and 42 use a template approach, memory system 46 stores a data base of templates obtained from the user. Microprocessor 22 matches the first few seconds template that classifier 40 derives with the first few seconds templates that memory system 46 stores to determine when the received program content matches the user's desired program content. If microprocessor 22 matches the text that classifier 40 derives with text that memory system 46 stores, program segments meeting the user's preferences can be stored in the memory system for playback to the user by microprocessor 22 coupling to a decoder (not shown) program segments memory system 46 previously stored. The decoder drives audio amplifiers 32 and 34 so the user can listen to the previously stored program segments. For example, tuner 16 can be activated so memory system 46 stores all traffic program segments from morning news programs during a particular time period and the user accesses these program segments before driving to work by activating a key or set of keys on keyboard 48.

Tuner 16 can also be activated so memory system 46 stores an entire program of great interest to the user and which is broadcast to receiver 10 while the receiver power output state is inactive, i.e., when the user has not turned on receiver 10. Such a program can be manually selected by the user or receiver 10 can respond automatically to such a program, if appropriate.

Keyboard 48 includes keys for enabling the user to select predetermined broadcast stations and the other usual keys or buttons of a radio receiver, as well as a search key and a select key. The search key commands microprocessor 22 to scan tuner 16 through every carrier frequency in the frequency range of the tuner, in an attempt to find the preferred program content type of the user. The select key enables the user to cause microprocessor 22 to activate tuner 16 to a desired frequency or to a frequency modulated with a desired program content type.

Receiver 10 also includes display 52, driven by output signals of microprocessor 22. Display 52 indicates the frequency and program type to which tuner 16 is tuned. In addition, microprocessor 22 and memory system 46 can store text indications of program type of every available program source and supply these text indications to display 52. If the device is in an automotive vehicle, images of the display can be projected on the front windshield of the vehicle.

Each time the on/off switch of receiver 10 is activated to the on state, the receiver determines the available stations in the region where the receiver is located. The frequency associated with each available broadcast source, i.e., each available station, is stored in memory system 46. To these ends, in response to the on/off switch being activated to the on state, memory system 46 commands microprocessor 22 to supply a stair step voltage to tuner 14. Each “landing” of the stair step voltage has a short duration, such as a few milliseconds; the duration is sufficiently long to enable signal strength detector 23 to derive a DC voltage indicative of the strength of the envelope that tuner 14 passes to IF amplifier 18. Hence, detector 23 derives a series of DC voltages, one for each frequency in the frequency range of receiver 10, starting from, e.g. the lowest frequency in the range to the highest frequency in the range.

Microprocessor 22 responds to each of the sequential DC voltages detector 23 derives and determines if the voltages above or below a threshold value indicative of a station being available for reception in the area where receiver 10 is located. Microprocessor 22 supplies memory system 46 with an indication of the frequency of each such available station. The foregoing operations are performed regardless of whether the receiver operates in the explicit or implicit mode, or in a mode combining both the implicit and explicit modes.

Before receiver 10 can operate in the explicit mode, memory system 46 initially responds to receiver 10 being turned on by activating microprocessor 22 so that the microprocessor supplies sequential initial prompts to display 52. If receiver 10 does not include an identification transducer 50, the first prompt tells the user to activate a key or set of keys on keyboard 48 for user identification purposes. If identification transducer 50 is included in receiver 10, the first prompt tells the user to position him or herself properly for identification by transducer 50.

During initial set up of receiver 10, memory system 46 then activates microprocessor 22 to cause the microprocessor to supply a second prompt to display 52. The second prompt tells the user to activate keyboard 48 in accordance with the call letters and/or frequencies of the available preferred stations of the user, i.e., the stations the user is likely to want to hear. While the second prompt is usually only performed during initial set up, in can be performed when the user first turns the receiver on, e.g., when the receiver is in a region different from where it is usually located the user can decide to have the second prompt performed by activating a key or set of keys on keyboard 48. Alternatively, memory system 46 controls microprocessor 22 to scan tuner 16 through each of the frequencies in the frequency range to which receiver 10 is responsive. As microprocessor 22 scans tuner 16, the microprocessor supplies display 52 with an indication of each frequency. In response to the user hearing a broadcast of interest, the user activates a select key on keyboard 48. Microprocessor 22 responds to the activated select key to cause memory system 46 to store the output of classifier 40 as an explicit preferred program type.

Memory system 46 then supplies microprocessor 22 with signals causing display 52 to list different program types sequentially and an instruction to the user to activate the keyboard select key each time a program type which the user prefers appears on display 52. Microprocessor 22 and memory system 46 respond to the activations of the select key to cause the memory system to store each selected program type as an explicit preferred program type. The user's explicit program preference types are thus stored in memory system 46.

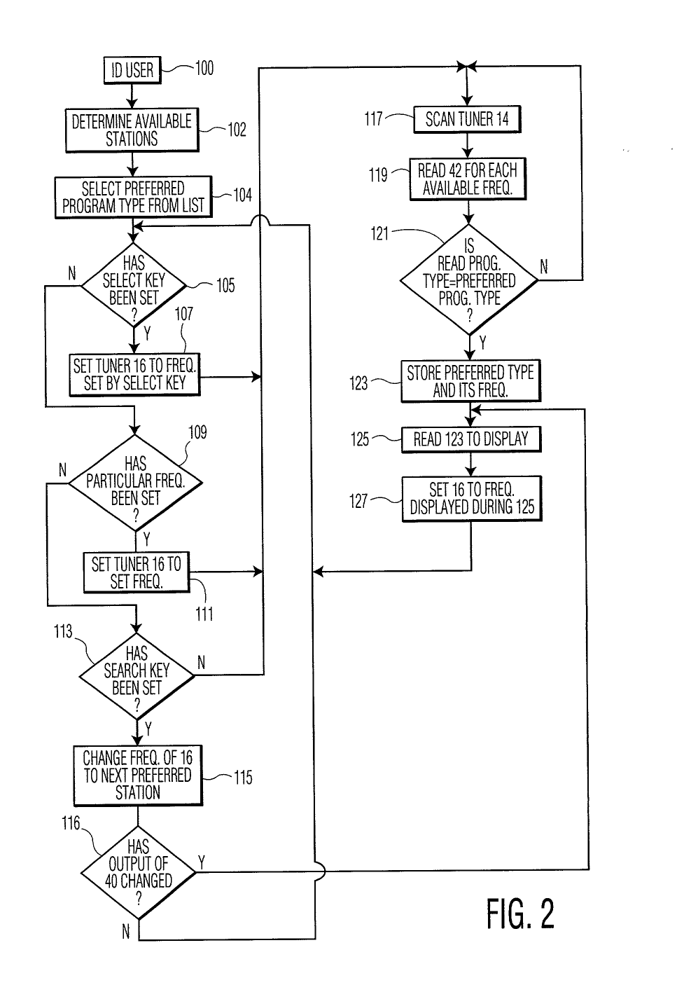

Reference is now made to FIG. 2 of the drawing, a flow diagram of operations microprocessor 22 performs in response to a program that memory system 46 stores when receiver 10 operates in the explicit mode and after memory system 46 has stored the explicit preferences. In operation, in response to receiver 10 being activated to an on state, memory system 46 activates microprocessor 22 to obtain an identification of the user of the receiver; operation 100. If receiver 10 includes identification transducer 50, microprocessor 22 reads the signal transducer 50 is deriving and supplies it to memory system 46 which automatically identifies the user from the information which was supplied to the memory during the prompt operations. If receiver 10 does not include identification transducer 50, microprocessor 22 sequentially reads one or more user identification prompts from memory system 46 to display 52. When display 52 presents the correct identification prompt, the user activates the select key on keyboard 48, causing memory system 46 to store a signal indicative of the user. Microprocessor 22 then activates memory system 46 to determine the available stations and the preferred program content type or types for the user; operations 102 and 104.

Microprocessor 22 and memory system 46 perform operation 102 by quickly scanning tuner 14 through each frequency in the frequency band of receiver 10. Microprocessor 22 responds to the signal strength output of detector 23 to determine if the signal level for each frequency is greater or less than the threshold. Memory system 46 stores an indication of each frequency having a signal strength greater than the threshold. During subsequent use of receiver 10, microprocessor 22 and memory system 46 cause tuner 14 to be scanned only to those frequencies which exceed the threshold.

The program then performs operation 105 during which a determination is made as to whether the keyboard 48 select key has been set. If operation 105 provides a “yes” response, the program advances to operation 107 during which microprocessor 22 and memory system 46 cause tuner 16 to be set to the selected frequency. If operation 105 provides a “no” response, microprocessor 22 and memory system 46 determine if a particular frequency of keyboard 48 has been set; operation 109. If operation 109 indicates a particular frequency of keyboard 48 has been set, microprocessor 22 and memory system 46 set tuner 16 to the frequency designated by the set key of keyboard 48; operation 111. If operation 109 indicates a particular frequency of keyboard 48 has not been set, the program advances to operation 113, during which a determination is made as to whether the search key of keyboard 48 has been set. In response to operation 113 providing a “yes” response, the program advances to operation 115 during which the frequency of tuner 16 is changed to the next preferred frequency for the user. Upon completion of operation 115, the program advances to operation 116 during which microprocessor 22 and memory system 46 determine if the output of classifier 40 has changed. In response to operation 116 yielding a “no” response, the program returns to operation 105.

Memory system 46 is programmed so operation 117 is reached in response to completion of operations 107 or 111 or in response to operation 113 indicating that the search key is not set. During operation 117, memory system 46 activates microprocessor 22 to scan through the available stations, starting at the frequency to which tuner 16 was previously set. Operation 117 continues the entire time receiver 10 is turned on. Tuner 14 dwells on the frequency associated with each available station for sufficient time to enable classifier 42 to detect the program content of the received signal passed through tuner 14; a typical dwell time is 30 seconds. Upon completion of operation 117, the program advances to operation 119 during which memory system 46 activates microprocessor 22 to read the program content output signal of classifier 42 immediately before the microprocessor changes the frequency that tuner 14 passes. Memory system 46 stores each output of classifier 42, as determined by operation 119, in association with each frequency of tuner 14.

Memory system 46 then activates itself and microprocessor 22 to make a determination as to whether the program content type that classifier 42 just applied to the microprocessor is the same as the preferred program content type memory system 46 stores for the user; operation 121. In response to operation 121 yielding a “yes” result, microprocessor 22 activates memory system 46 to operation 123 during which memory system 46 stores the frequency and program content determined during operation 119 associated with the “yes” result from operation 121. Upon completion of operation 123, the program advances to operation 125 during which the signals stored in memory system 46 indicative of the preferred frequencies and program content of the user are sequentially read to display 52. Operation 125 is also performed in response to operation 116 yielding a “yes” result indicating there has been a change in the output of classifier 40. If the user wants to listen to one of the sequentially displayed frequencies and program content, he activates the select key on keyboard 48. If the user immediately decides he does not want to listen to the displayed program content and/or frequency he activates the search key on keyboard 48, causing operation 115 to be executed during the next program cycle.

In one embodiment, upon completion of operation 125, the program returns to operation 105 and the process is constantly repeated. Thus, tuner 16 is set to the displayed frequency having the preferred program type and remains at the set frequency until the user activates the search key or a frequency key or the select key or the program content that speakers 28 and 30 supply to the user changes.

In another embodiment, as illustrated in FIG. 2, the program advances from operation 125 to operation 127 during which microprocessor 22 and memory system 46 set tuner 16 to the frequency displayed during operation 125. Speakers 28 and 30 thus provide the user with preferred program content without intervention by the user. If the user decides he does not want to listen to the program content he activates the search key, causing operation 113 to be performed during the next program cycle. Upon completion of operation 127, the program returns to operation 105.

Consideration is now given to the operations memory system 46 stores to command operation of microprocessor 22 for the implicit mode. In the implicit mode, the user does not select program preferences. Instead, memory system 46 adapts to or learns the user's listening preferences by responding to indications classifier 40 derives which indicate the program types the user selects.

Because memory system 46 does not initially store any preferences for each user, the receiver determines the user's preferences based on the program content of the stations the user selects in response to the second prompt discussed in connection with the explicit mode. Immediately after the user executes the second prompt, memory system 46 activates microprocessor 22 to tune tuner 14 to each of the frequencies which the user selected during the second prompt. Microprocessor 22 commands tuner 14 to dwell on each of these frequencies for a sufficient interval to enable classifier 42 to determine the program content type of the signal being passed by tuner 14; typically this interval is 30 seconds. The foregoing operation is performed for each user selected frequency having a sufficiently high level to cause the output of detector 23 to exceed the threshold. If the threshold is not exceeded, microprocessor 22 activates tuner 14 to cause the tuner to step to the next frequency the user entered during the second prompt. After all the frequencies which were entered during the second prompt have been supplied by tuner 14 and amplifier 18 to classifier 42, memory system 46 stores an initial indication of the user's preferred program content type.

Receiver 10 learns the user's actual program content type preferences by microprocessor 22 and memory system 46 responding to the output of classifier 40. The only difference between the operations of microprocessor 22 and memory system 46 for the explicit and implicit modes is that the output of classifier is detected in the implicit mode immediately before operation 105, FIG. 2, being performed. Microprocessor 22 responds to the signal that classifier 40 derives and loads memory system 46 with this signal. The signal that classifier 40 derives can supercede the preference signals previously loaded into memory system 46 or can be combined with the previously loaded preference signals. If the signal from classifier 40 and the previously stored preference signals are combined, the signal that classifier 40 derives is weighted by the number of times the same signal is read to microprocessor 22 and memory system 46.

If the explicit and implicit modes are combined, the user is prompted through all three steps discussed in connection with the explicit mode. Because the preferences are thereby loaded into memory system 46, there is no need for the memory system of microprocessor 22 to scan tuner 14, to initially determine the program content type of each available station.

In the combined mode, microprocessor 22 reads the output of classifier 40 as described for the implicit mode. The program content signal that classifier 40 derives modifies the preferences which were supplied to memory 46 during the third prompt described in connection with the explicit mode. As previously described, the signal read from classifier 40 is preferably weighted by the number of times classifier derives the same preference.

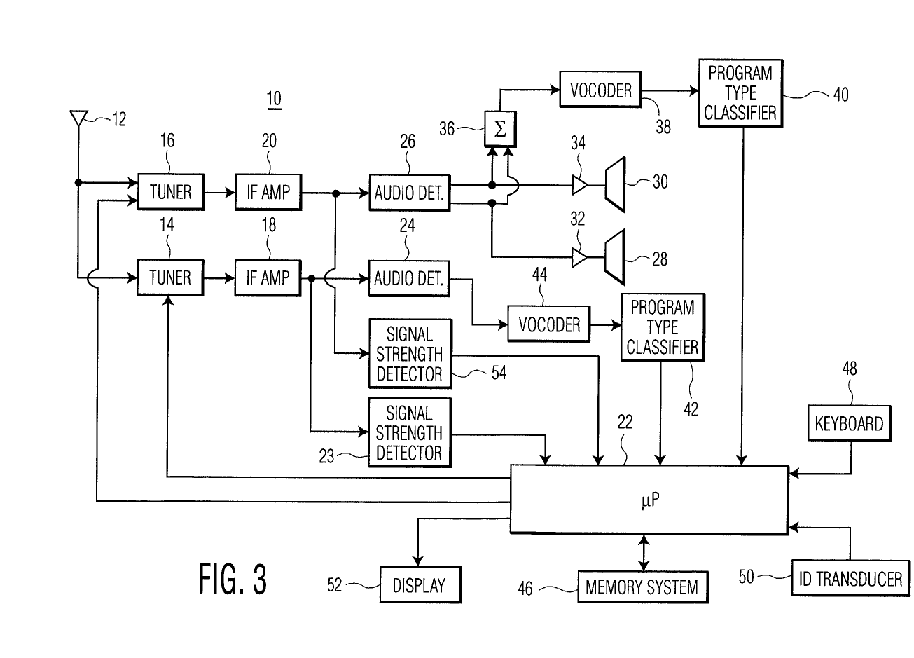

Reference is now made to FIG. 3 of the drawing, a block diagram of a second embodiment of the invention. The embodiment of FIG. 3 is the same as the embodiment of FIG. 1, except that signal strength detector 54, having a construction identical to signal strength detector 23, is connected to respond to the output of IF amplifier 20. Signal strength detector 54 drives one input of microprocessor 22 to enable the microprocessor to detect whether the signal to which tuner 16 is tuned is sufficiently strong.

While there have been described and illustrated specific embodiments of the invention, it will be clear that variations in the details of the embodiments specifically illustrated and described may be made without departing from the true spirit and scope of the invention as defined in the appended claims. For example, while the invention has been described in connection with a radio receiver, it is to be understood that the concepts of the invention can be employed in connection with a television receiver by responding to the detected television receiver audio signal. Concepts of the invention can also be used in connection with stored information indicative of program content of programs to be transmitted by radio broadcasters. A list of approximately 10,000 radio stations in the United States and around the world that host an Internet website with programming information can be found at HTTP://wmbr.mit.edu/stations/list.HTML. The programming information can be stored in memory system 46 and compared in microprocessor 22 with text outputs of classifiers 40 and 42 to control or assist in manual control of tuners 14 and 16. The invention is also applicable to multiple users. In such a case, the preferred programs of both users are displayed and/or automatically selected or the system can determine the preferred programs when both users are present and respond accordingly.

We claim:

1. An entertainment receiver including a tuner arrangement, a controller for the tuner arrangement, the controller including a signal storing arrangement for storing at least one preference for program content type of a user of the receiver, the controller and the tuner arrangement being coupled to each other for deriving, in response to received program content, a signal for enabling the tuner arrangement to be tuned to a carrier frequency of a program source having a program content type corresponding with the preference for the program type of the user.

2. The entertainment receiver of claim 1, wherein the tuner arrangement includes plural tuners, the controller being arranged for activating a first of the tuners through a gamut of frequencies, a program content type classifier connected to be responsive to said first tuner, the controller being arranged to be responsive to the program content type classifier, and the stored program content type preference for deriving the signal.

3. The entertainment receiver of claim 2 further including a signal-level detector connected to be responsive to the amplitude of a signal passing through second tuner dropping below a threshold for activating the controller to derive an output for enabling the second tuner to be tuned to pass a carrier frequency of a program source having a program content type corresponding with the preference for the program type of the user and which has a amplitude above the threshold.

4. The entertainment receiver of claim 3 wherein the controller is arranged for causing the output to activate the tuner to said carrier frequency.

5. The entertainment receiver of claim 1 wherein the controller is arranged for causing the signal to activate the tuner arrangement to be tuned to said carrier frequency.

6. The entertainment receiver of claim 1 further including a signal level detector connected to be responsive to the amplitude of the signal having the carrier frequency of the program source having a program content type corresponding with the preference for the program type of the user dropping below a threshold for activating the controller to cause the tuner arrangement to be tuned to pass a carrier frequency of a program source having a program content type corresponding with the preference for the program type of the user and which has an amplitude above the threshold.

7. The entertainment receiver of claim 1 wherein the signal storing arrangement stores at least one preference for program content type in response to input signals associated with inputs of the user derived from sources other than received program content.

8. The entertainment receiver of claim 1 wherein the signal storing arrangement stores at least one preference for program content type in response to received program content.

9. The entertainment receiver of claim 1 wherein the signal storing arrangement stores at least one preference for program content type in response to input signals associated with inputs of the user derived from sources other than received program content and received program content.

10. The entertainment receiver of claim 1 wherein the signal storing arrangement stores at least one preference for each of plural predetermined users and further including an input device for enabling identification of which of the predetermined users is using the receiver, the controller being arranged to be responsive to the input device for tuning the receiver to a carrier frequency of a program source having a program content type corresponding with the preference for the program type of the identified user.

11. The entertainment receiver of claim 1 further including a display connected to be responsive to the signal for displaying an indication of at least one of said carrier frequency and the program content type of said program source.

12. A method of tuning an entertainment receiver comprising storing at least one signal indicative of preferred program content type for a user of the receiver; determining, in response to received and detected program content type, program content type of a plurality of program sources received by the receiver; comparing the program content type of the plurality of program sources received by the receiver with the stored at least one signal indicative of preferred program content type for a user of the receiver; and activating the receiver so a received program source with the preferred program content type is presented to the user.

13. The method of claim 12 further including activating a first tuner of the receiver through a gamut of frequencies, classifying the program content type of program segments passed through the first tuner for frequencies in the gamut of frequencies, performing the comparing step in response to the classified program content type passed through the first tuner, and performing the activating step by setting a second tuner to pass a carrier frequency of a received program source with the preferred program content type.

14. The method of claim 13 further including changing the carrier frequency passed by the second tuner to a carrier frequency of another received program source with the preferred program content type in response to the amplitude of the signal level passed by the second tuner dropping below a threshold level.

15. The method of claim 12 further including changing the program source tuned to by the receiver to another received program source with the preferred program content type in response to the amplitude of the received program source dropping below a threshold level.

16. The method of claim 15 wherein the changing step is performed by performing the determining, comparing and activating steps.

17. The method of claim 12 further including storing the program content type signals by supplying to a storage arrangement a carrier frequency of a program source having a program content type corresponding with the preference for the program type of the user.

18. The method of claim 12 further including storing the program content type signals resulting from received program content by supplying to a storage arrangement a carrier frequency of a program source having a program content type corresponding with the preference for the program type of the user.

19. The method of claim 12 further including storing the program content type signals by supplying to a storage arrangement a carrier frequency of a program source having a program content type corresponding with the preference for the program type of the user and signals resulting from received program content.

20. The method of claim 12 further including storing at least one preference for each of plural predetermined users, identifying which of the predetermined users is using the receiver, and tuning the receiver to a carrier frequency of a program source having a program content type corresponding with the preference for the program type of the identified user.
